(19) United States
(12) Patent Application Publication
(10) Pub. No.: US 2024/0430823 A1
(43) Pub. Date: Dec. 26, 2024

(54) RADIO FREQUENCY EXPOSURE DISTRIBUTION FOR MULTI-LINK SERVICE

(71) Applicant: QUALCOMM Incorporated, San Diego, CA (US)

(72) Inventors: Michael Siddhartha ARPUTHARAJ, Hyderabad (IN); Narasimhamurthy VEMPATI, Hyderabad (IN); Venkatesh SASANAPURI, Hyderabad (IN); Kaushik BHATTACHARYA, Hyderabad (IN); Suman CHAKRABORTY, Hyderabad (IN)

(21) Appl. No.: 18/340,780

(22) Filed: Jun. 23, 2023

(51) Int. Cl. H04W 52/36; H04W 52/22

(52) U.S. Cl. CPC H04W 52/367; H04W 52/225; H04W 84/12

(57) ABSTRACT

Certain aspects of the present disclosure provide techniques and apparatus for distributing a transmit power budget for a multi-link service in compliance with a radio frequency (RF) exposure limit. An example method of wireless communication includes obtaining a transmit power budget associated with a time interval. The method further includes determining, for each of a plurality of communication links, a first transmit power based at least in part on the transmit power budget and one or more properties associated with the communication links in response to detecting a particular service associated with the communication links is active. The method further includes transmitting a signal using at least one of the respective first transmit powers associated with the communication links in the time interval.

### BACKGROUND

### Field of the Disclosure

Aspects of the present disclosure relate to wireless communications, and more particularly, to radio frequency (RF) exposure compliance.

### Description of Related Art

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

### SUMMARY

Some aspects provide a method of wireless communication by a wireless device. The method includes obtaining a transmit power budget associated with a time interval. The method further includes determining, for each of a plurality of communication links, a first transmit power based at least in part on the transmit power budget and one or more properties associated with the communication links in response to detecting a particular service associated with the communication links is active. The method further includes transmitting a signal using at least one of the respective first transmit powers associated with the communication links in the time interval.

Some aspects provide a method of wireless communication by a wireless device. The method includes obtaining an indication that a particular service is active. The method further includes determining, for a time interval, a first transmit power budget for a first radio access technology (RAT) and a second transmit power budget for a second RAT in response to obtaining the indication. The method further includes transmitting one or more signals in the time interval at one or more transmit powers in compliance with the first transmit power budget and the second transmit power budget.

Some aspects provide an apparatus for wireless communication. The apparatus includes a memory and one or more processors coupled to the memory. The one or more processors are configured to obtain a transmit power budget associated with a time interval, determine, for each of a plurality of communication links, a first transmit power based at least in part on the transmit power budget and one or more properties associated with the communication links in response to detecting a particular service associated with the communication links is active, and control transmission of a signal using at least one of the respective first transmit powers associated with the communication links in the time interval.

Some aspects provide an apparatus for wireless communication. The apparatus includes a memory and one or more processors coupled to the memory. The one or more processors are configured to obtain an indication that a particular service is active, determine, for a time interval, a first transmit power budget for a first RAT and a second transmit power budget for a second RAT in response to obtaining the indication, and control transmission of one or more signals in the time interval at one or more transmit powers in compliance with the first transmit power budget and the second transmit power budget.

Some aspects provide an apparatus for wireless communication. The apparatus includes means for obtaining a transmit power budget associated with a time interval. The apparatus further includes means for determining, for each of a plurality of communication links, a first transmit power based at least in part on the transmit power budget and one or more properties associated with the communication links in response to detecting a particular service associated with the communication links is active. The apparatus further includes means for transmitting a signal using at least one of the respective first transmit powers associated with the communication links in the time interval.

Some aspects provide an apparatus for wireless communication. The apparatus includes means for obtaining an indication that a particular service is active. The apparatus further includes means for determining, for a time interval, a first transmit power budget for a first RAT and a second transmit power budget for a second RAT in response to obtaining the indication. The apparatus further includes means for transmitting one or more signals in the time interval at one or more transmit powers in compliance with the first transmit power budget and the second transmit power budget.

Some aspects provide a non-transitory computer-readable medium. The computer-readable medium has instructions stored thereon, that when executed by an apparatus, cause the apparatus to perform a method. The method includes obtaining a transmit power budget associated with a time interval. The method further includes determining, for each of a plurality of communication links, a first transmit power based at least in part on the transmit power budget and one or more properties associated with the communication links in response to detecting a particular service associated with the communication links is active. The method further includes transmitting a signal using at least one of the respective first transmit powers associated with the communication links in the time interval.

Some aspects provide a non-transitory computer-readable medium. The computer-readable medium has instructions stored thereon, that when executed by an apparatus, cause the apparatus to perform a method. The method includes obtaining an indication that a particular service is active. The method further includes determining, for a time interval, a first transmit power budget for a first RAT and a second transmit power budget for a second RAT in response to obtaining the indication. The method further includes transmitting one or more signals in the time interval at one or more transmit powers in compliance with the first transmit power budget and the second transmit power budget.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human.

FIG. 2 is a block diagram conceptually illustrating a design of an example wireless communication device communicating with another device.

FIG. 3 is a graph illustrating examples of transmit powers over time in compliance with an RF exposure limit.

FIG. 4 is a diagram illustrating an example wireless device having multiple radios.

FIG. 5 is a diagram of an example multi-link service architecture.

FIG. 6 is a diagram illustrating an example logical architecture for controlling transmit powers associated with one or more radios.

FIG. 7 is a flow diagram illustrating example operations for wireless communication by a wireless device.

FIG. 8 is a flow diagram illustrating example operations for wireless communication by a wireless device.

FIG. 9 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for distributing a transmit power budget for a multi-link service in compliance with a radio frequency (RF) exposure limit. A multi-link service may include a service that uses multiple communication links via one or more radio access technologies.

A wireless communication device may be capable of communicating via multiple radio access technologies (RATs). As an example, the RATs may include wireless wide area network (WWAN) RAT(s) (e.g., 5G New Radio, Evolved Universal Terrestrial Radio Access (E-UTRA), Universal Mobile Telecommunications System (UMTS) and/or code division multiple access (CDMA)), wireless local area network (WLAN) RATs (e.g., IEEE 802.11), short-range communications (e.g., Bluetooth), non-terrestrial communications, device-to-device (D2D) communications, vehicle-to-everything (V2X) communications, and/or other communications (e.g., future RAT(s)). In some cases, the wireless device may control RF exposure using a centralized controller that distributes a transmit power budget among multiples radios associated with one or more RATs associated with particular radios for one or more RATs, where the transmit power budget may correspond to an RF exposure limit.

To control the RF exposure associated with multiple radios (e.g., WLAN, WWAN (E-UTRA/5G), and Bluetooth), a time-averaged evaluation may have two components: an outer loop (OL) that periodically determines a particular transmit power budget for each of the radios, and an inner loop (IL) for each of the radios that uses the respective transmit power budget to determine its transmit power for a specific time interval of a running time window or for each packet. The OL may compute the transmit power limit based on a transmit power history report provided by the inner loop associated with each of the radios, where the transmit power history report may indicate the transmit powers used over time in the previous time interval(s). In certain cases, the OL and/or IL may not be aware of a particular service that uses multiple communication links, such as an extended personal audio network (XPAN). In an XPAN, the wireless device may use multiple communications links and multiple RATs to send, for example, high quality audio (lossless or lossy) to a user's wireless earbuds or headphones from the wireless device. As such, the OL and/or IL may not efficiently distribute the transmit power budget among the communication links to facilitate the traffic demands of the communication links.

Aspects of the present disclosure provide apparatus and methods for efficiently distributing a transmit power budget among multiple communication links associated with a service. A wireless device may detect that a particular multi-link service, such as XPAN, is active. In response to such a detection, the wireless device may distribute a transmit power budget associated with an RF exposure limit (or any other suitable transmit power control as further described herein) among the communication links of the multi-link service. Suppose, for example that the multi-link service has three communication links, each with one or more specific link properties. The respective properties of a communication link may include a duty cycle, a throughput, a latency, and/or a transmission distance, for example. The wireless device may distribute the transmit power budget among the three communication links based on the properties of the links, as further described herein.

The apparatus and methods for multi-link service RF exposure compliance described herein may provide various advantages. For example, the multi-link service power distribution may improve wireless communication performance, including, for example, an increased throughput, decreased latency, and/or increased transmission range, where the improved performance may be attributable to efficient distribution of transmit powers to multiple communications associated with a particular service. For example, the wireless device may distribute the transmit power budget among the communication links associated with the service based on the properties of the links, as further described herein.

As used herein, a radio may refer to a physical or logical transmission path associated with one or more frequency bands (carriers, channels, bandwidths, subdivisions thereof, etc.), transceivers, and/or radio access technologies (RATs) (e.g., wireless wide area network (WWAN), wireless local area network (WLAN), short-range communications (Bluetooth), non-terrestrial communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for IEEE 802.11 may be treated as separate radios for each frequency band (e.g., 2.4 GHz, 5 GHZ, or 6 GHz).

### Example RF Exposure Compliance

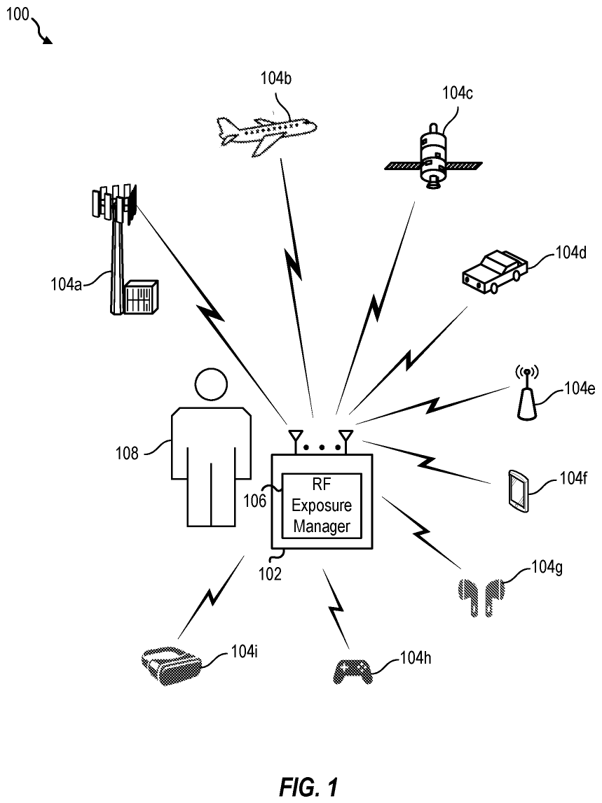

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio system (e.g., a 5G NR network), an Evolved Universal Terrestrial Radio Access (E-UTRA) system (e.g., a 4G network), a Universal Mobile Telecommunications System (UMTS) (e.g., a 2G/3G network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that distributes a transmit power budget for a multi-link service in compliance with an RF exposure limit, in accordance with aspects of the present disclosure.

The second wireless devices 104a-f may include, for example, a base station 104a, an aircraft 104b, a satellite 104c, a vehicle 104d, an access point (AP) 104e, a UE 104f, an audio output device 104g (e.g., wireless earbuds), an input device 104h (e.g., a wireless controller), and/or a headset 104i (e.g., a virtual reality or augmented reality headset). Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In some cases, the RF exposure may be expressed in terms of a specific energy absorption (SA) limit or an absorbed energy density (Uab) limit, for example, for a total RF energy limit allowed in a specific time period. In certain cases, a maximum permissible exposure (MPE) limit in terms of PD may be imposed for wireless communication devices using transmission frequencies above 6 GHz. Frequency bands of 24 GHz to 71 GHz or greater are sometimes referred to as a “millimeter wave” (“mmW” or “mmWave”). The MPE limit is a regulatory metric for exposure based on area, e.g., an energy density limit defined as a number, X, watts per square meter (W/m2) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

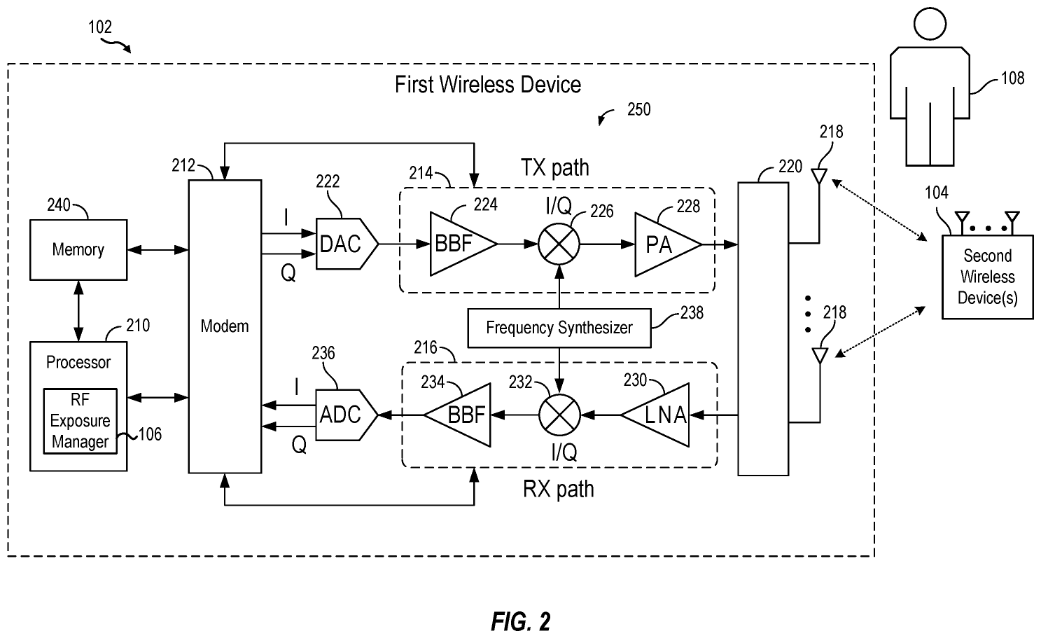

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. For example, the processor 210 may be representative of one or more co-processors (e.g., one or more microprocessors) associated with the modem 212, and the modem 212 may be representative of one or more ASICs including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands) under a proposed regulation, for example.

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

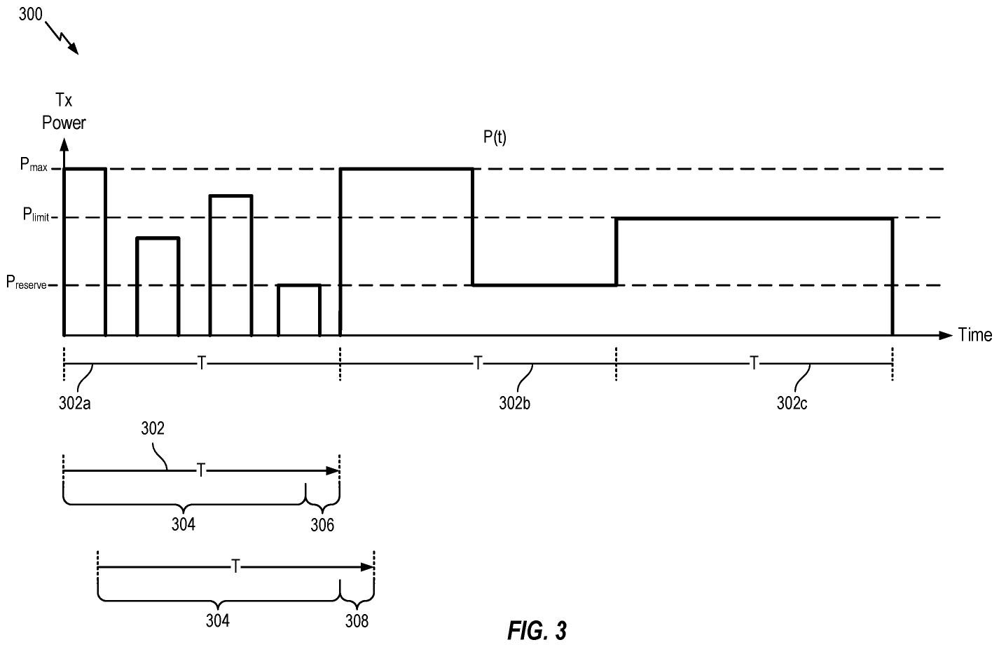

FIG. 3 is a graph 300 of a transmit power over time (P (t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling, high priority communications, low latency communications, highly reliable communications, etc.). Pᵣₑₛₑᵣᵥₑ may be used to reserve transmit power for at least a portion of the time window 302 for certain transmissions (e.g., control signaling).

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P (t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with a total transmit time of one or more transmissions in the time period, where the one or more transmissions may include bursts of transmissions having a gap of time positioned between at least two of the bursts. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior.

As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

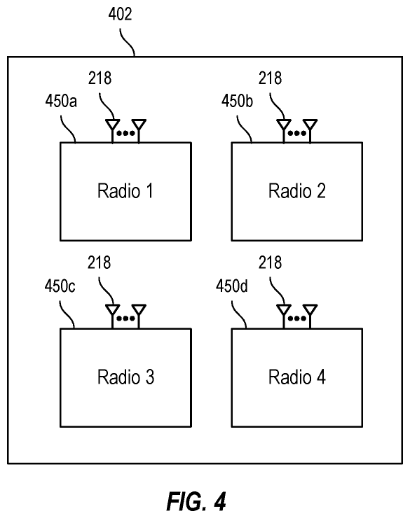

FIG. 4 is a diagram illustrating an example wireless device 402 (e.g., the first wireless device 102) having multiple radios 450a-d (e.g., the radios 250). In this example, the radios 450a-d may be associated with any of various RATs and/or frequency bands, channels, bandwidths, carriers, etc. For example, the first radio 450a may communicate via WWAN RAT(s) (e.g., E-UTRA and/or 5G NR) in sub-6 GHz frequency bands. The second radio 450b may communicate via WWAN RAT(s) (e.g., 5G NR) in mmWave frequency bands. The third radio 450c may communicate via WLAN RAT(s) in sub-6 GHz (e.g., 2.4 GHz, 5 GHZ, and/or 6 GHZ) frequency bands. The fourth radio 450d may communicate via short-range communications (e.g., Bluetooth) in a 2.4 GHz frequency band. While this example shows a wireless device having four radios, a wireless device may have any number of radios for wireless communications, such as a radio per one or more frequency bands associated with WWAN and/or WLAN communications, a radio per RAT, and/or a radio capable of communicating via multiple RATs.

In certain cases, the OL and/or IL may not be aware of a particular service that uses multiple communication links, such as an extended personal audio network (XPAN). In an XPAN, the wireless device may communicate via a communication link using Bluetooth and via at least two more communication links using WLAN. The Bluetooth communication link and a first WLAN communication link may be with a wireless audio output device (e.g., headphones or earbuds), and a second WLAN communication link may be with an access point. Each of the communication links in the XPAN service may have specific properties. For example, the Bluetooth communication link may carry light traffic; the first WLAN communication link may have a traffic pattern associated with streaming audio in various levels of quality (e.g., lossless audio format(s) and/or lossy audio format(s)); and the second WLAN communication link may provide the infrastructure connection to one or more services including the streaming audio transmitted to the audio output device. As such, the OL and/or IL may not efficiently distribute the transmit power budget among the communication links to facilitate the traffic demands of the communication links.

### Example Radio Frequency Exposure Distribution for Multi-Link Service

Aspects of the present disclosure provide apparatus and methods for efficiently distributing a transmit power budget among multiple communication links associated with a service. A wireless device may detect that a particular multi-link service, such as XPAN, is active. In response to such a detection, the wireless device may distribute a transmit power budget associated with an RF exposure limit (or any other suitable transmit power control as further described herein) among the communication links of the multi-link service. As an example, the multi-link service may have three communication links, each with one or more specific link properties. The respective properties of a communication link may include a duty cycle, a throughput, a latency, and/or a transmission distance, for example. The wireless device may distribute the transmit power budget among the three communication links based on the properties of the links, as further described herein. In some cases, the multi-link service may include communication links associated with multiple RATs. In such cases, the wireless device may distribute separate transmit power budgets to the different RATs, and the respective transmit power budget of a RAT may be further distributed among communication links as further described herein.

The apparatus and methods for multi-link service RF exposure compliance described herein may provide various advantages. For example, the multi-link service power distribution may improve wireless communication performance, including, for example, an increased throughput, decreased latency, and/or increased transmission range, where the improved performance may be attributable to efficient distribution of transmit powers to multiple communications associated with a particular service. For example, the wireless device may distribute the transmit power budget among the communication links associated with the service based on the properties of the links, as further described herein.

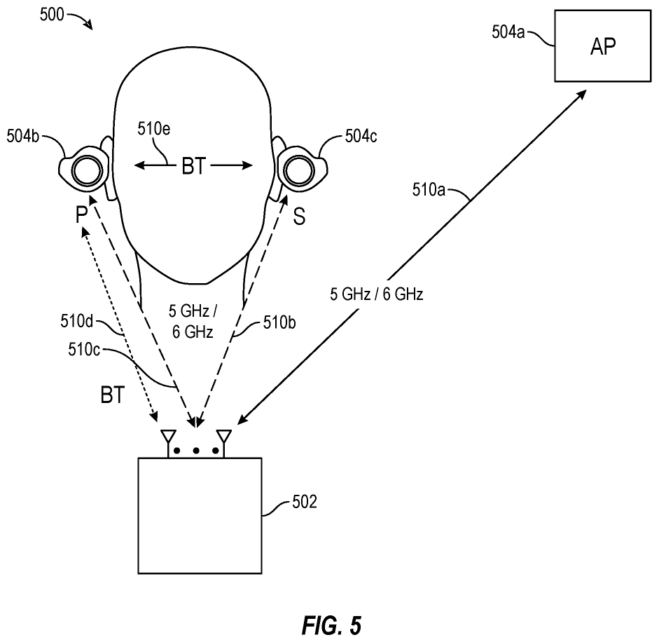

FIG. 5 is a diagram of an example multi-link service architecture 500. In this example, the multi-link service architecture 500 may be representative of an XPAN using WLAN and Bluetooth communications to stream audio to one or more wireless audio output devices (e.g., second wireless devices 504b, 504c), such as wireless headphones and/or ear buds as depicted in FIG. 5. The audio output device(s) in an XPAN may be or include any suitable device that outputs sounds, such as a loudspeaker, subwoofer, mid-range, tweeter, sound bar, speaker system, etc. The XPAN may enable high quality (e.g., lossless or lossy formats) and/or low latency audio to be streamed to the audio output devices via the dedicated WLAN communication links.

In the multi-link service architecture 500, a first wireless device 502 (e.g., the first wireless device 102) may be in communication with second wireless devices 504a-c (e.g., the second wireless devices 104), for example, via communication links 510a-d, which may be through multiple RATs (e.g., WLAN and Bluetooth). In some cases, first wireless device 502 may include a portable computing device (e.g., a smartphone or tablet), a gaming console (e.g., a portable gaming device), an audio streaming device, a smart home device, etc.

As an example, the communication links 510a-c may be associated with a WLAN RAT, and the fourth communication link 510d may be associated with a Bluetooth RAT. The communication links 510a-c may be in any frequency band or channel thereof associated with WLAN communications. For example, the first communication link 510a may be in a 6 GHz band, and the second and third communication links 510b, 510c may be in a 5 GHz band. In some cases, the second wireless devices 504b, 504c may be in communication with each other via a fifth communication link 510e through the Bluetooth RAT.

The first communication link 510a may be between the first wireless device 502 and the second wireless device 504a (e.g., the AP), and the remaining communication links 510b-d may be between the first wireless device 502 and the second wireless devices 504b, 504c (e.g., wireless earbuds). The first communication link 510a may carry various traffic including audio streaming traffic; the second and third communication links 510b, 510c may carry at least the audio streaming traffic to the second wireless devices 504b, 504c; and the fourth communication link 510d may carry certain traffic associated with the ear buds, such as volume controls, audio playback controls, voice call controls, establishment of the XPAN, etc. The first communication link 510a may sometimes be referred to as an infrastructure (infra) link, and the second and third communication links 510b, 510c may be collectively referred to as an XPAN link or audio link. In some cases, the second and third communication links 510b, 510c may be implemented as (or representative of) a single communication link, for example, in the case of headphones or another suitable audio output device. The first wireless device 502 may be connected to the second wireless device 504a in STA mode, and the first wireless device 502 may be connected to the second wireless devices 504b, 504c in service access point (SAP) mode.

In certain aspects, the first wireless device 502 may distribute a transmit power budget associated with an RF exposure limit (or any other suitable transmit power control) among the communication links 510a-d based at least in part on properties associated with the communication links 510a-d. For example, in some cases, the second wireless devices 504b, 504c may be positioned closer to the first wireless device 502 compared to the second wireless device 504a. In such cases, the communication links 510b-d may have a smaller path loss compared to the first communication link 510a. The first wireless device 502 may adjust the transmit power budget distribution based at least part on the path losses and/or transmission ranges associated with the communication links 510a-d.

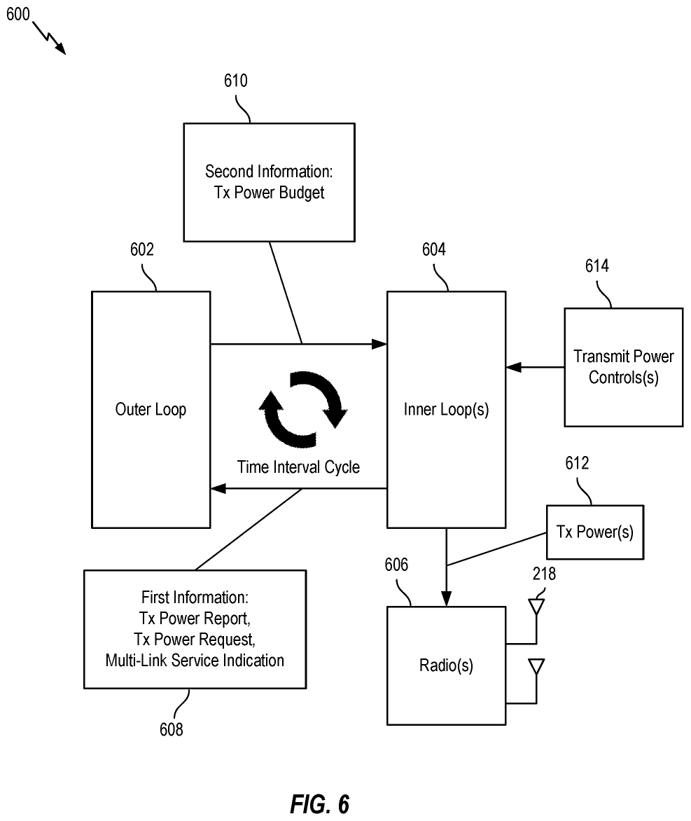

FIG. 6 is a diagram illustrating an example logical architecture 600 for controlling the transmit power (and hence, the RF exposure, RF emissions, RF interference, etc.) associated with one or more radios 606 (e.g., the radio(s) 450a-d) of a wireless device (e.g., the wireless device 402). As the outer loop 602 and the inner loop(s) 604 control transmit power(s) applied at the radio(s) 606 to be in compliance with an RF exposure limit, aspects of the outer loop 602 and/or the inner loop(s) 604 may be representative of the RF exposure manager 106. In certain aspects, the outer loop 602 may be representative of a centralized RF exposure manager, and the inner loop(s) may be representative of transmit power manager(s) associated with the radio(s) 606, as further described herein. As an example, the outer loop 602 may be implemented in a WWAN modem, and at least one of the inner loops 604 may be implemented in a WLAN modem or a multi-RAT modem (e.g., a modem configured to perform WLAN and Bluetooth communications). With respect to FIG. 2, the outer loop 602 may be implemented in the processor 210 (which as described herein may include or be representative of, in some cases, a modem—e.g., a WWAN modem), and the inner loop 604 may be implemented in the modem 212—e.g., another modem, such as a WLAN modem. In some cases, the outer loop 602 and inner loop 604 may be implemented in the same modem and/or processor, e.g., the WWAN modem.

In this example, the outer loop 602 operates as a centralized controller that controls the RF exposure associated with the radios 606. The outer loop 602 may determine the maximum allowed transmit powers that can be used for a future time interval based on the past transmit powers associated with all (or some) of the radios 606 (e.g., the radios 606 that are actively transmitting). For example, the outer loop 602 may periodically (e.g., every 500 milliseconds) receive first information 608 from the inner loop(s) 604 associated with the radios 606. In some cases, the outer loop 602 may obtain the first information 608 in response to certain criteria (e.g., a triggering event including a change in channel conditions, quality of service (QOS), etc.). The periodicity in which the first information 608 is obtained at the outer loop 602 may correspond to a time interval cycle, such as following each future time interval 306, 308 of the rolling time window 302.

The first information 608 may include an indication of a transmit power report, an indication of a transmit power request associated with a respective inner loop 604, and/or a multi-link service indication. The indication of the transmit power request may include a requested transmit power or exposure margin for a future time interval (e.g., the time interval 306, 308). The indication of the transmit power report may include past transmit power history or an average transmit power associated with a time interval (e.g., a past time interval in a rolling time window, such as the past time interval 304 or the previous future time interval). A particular inner loop 604 may be associated with one or more radios (e.g., any of the radios 650a-d), and thus, the first information 608 may be associated with such radio(s). As an example, at least one of the inner loops 604 may provide the first information 608 associated with a WLAN radio to the outer loop 602. The multi-link service indication may include an indication of whether a multi-link service is active or inactive.

The outer loop 602 may determine separate transmit power budgets for the inner loops 604, for example, based on the first information 608 and/or other information (e.g., a particular transmit power budget allocation for an inner loop). In some aspects, the outer loop 602 may determine the transmit power budgets without the first information 608, for example, when an inner loop 604 is not configured to provide the first information 608. The transmit power budgets may be associated with a time interval, such as the future time interval 306, 308, in which to apply the transmit power budgets. The transmit power budgets for the inner loops 604 may comply with an RF exposure limit or any other suitable transmit power control. As an example, the inner loop(s) 604 may obtain the respective transmit power budgets before the future time interval occurs, and the inner loop(s) 604 may determine particular transmit power(s) to use in compliance with the respective transmit power budget(s).

To efficiently allocate the transmit power budget among the radios 606, for example, in a multi-link service scenario such as XPAN, the inner loop 604 (e.g., the inner loop 604 of the WLAN modem) may indicate (via the first information 608) to the outer loop 602 that the multi-link service is active and request to readjust the transmit power budget among the radios 606 (e.g., via the transmit power request in the first information 608). In response to the indication that the multi-link service is active, the outer loop 602 may distribute the total transmit power budget among the inner loops 604 based on one or more properties associated with the multi-link service. The outer loop 602 may distribute the total transmit power budget into separate transmit power budgets for the communication links associated with the multi-link service, such as WLAN communications and Bluetooth communications in an XPAN service scenario. As an example, the outer loop 602 may distribute the total transmit power budget into at least a first transmit power budget for WLAN communications and a second transmit power budget for Bluetooth communications. In some cases, the outer loop 602 may also distribute the total transmit power budget to other communications not associated with the multi-link service, such as WWAN communications, NTN communications, V2X communications, etc.

As an example, in an XPAN scenario, the traffic may be greater on the WLAN links (e.g., the infra link and the XPAN link as depicted in FIG. 5) compared to the Bluetooth link. The outer loop 602 may distribute a greater share of the total transmit power budget to the inner loop 604 for WLAN communications compared to the transmit power budget distributed to the inner loop 604 for Bluetooth communications. In order to maintain the Bluetooth link in a multi-link service scenario (e.g., XPAN), the outer loop 602 may allocate a base (minimum) reserve (e.g., Pᵣₑₛₑᵣᵥₑ) used for Bluetooth communications, and the outer loop 602 may allocate the rest of the transmit power budget (e.g., the rest of the budget available to Bluetooth and WLAN, which may be the totality of the budget for the wireless device 102, or in some cases, may be less than the totality of the budget, for example when some budget is assigned to one or more other RATs, such as WWAN) to the WLAN links (e.g., the infra link and the XPAN link) to boost the WLAN performance. The base reserve may correspond to a guaranteed transmit power level that can be maintained for a certain duration, such as a time interval in a time-averaging time window or the duration of such a time window. Further, as time progresses, based on the duty cycle in Bluetooth, the inner loop 604 associated with Bluetooth communication may renegotiate the transmit power budget for Bluetooth via the first information 608.

In certain aspects, the outer loop 602 may periodically provide second information 610 to the inner loop(s) 604, where the second information 610 may indicate the transmit power budgets associated with the inner loops 604. In some cases, each of the inner loops 604 may obtain the second information 610, which may indicate a portion of the total transmit power budget for each of the inner loops 604. For example, the outer loop 602 may provide a first transmit power budget to a first inner loop and a second transmit power budget to a second inner loop, where the first transmit power budget and the second transmit power budget are portions of the total transmit power budget distributed among the inner loops 604. In certain cases, a subset of the inner loops 604 may be assigned transmit power budgets, for example, when certain radio(s) are disabled or inactive (e.g., in an idle mode or sleep mode) and not expected to communicate in the respective time interval. In such cases, the outer loop 602 may provide the second information 610 to only a subset of the inner loops 604 that are actively transmitting in the time interval.

For certain aspects, the inner loop 604 may operate in a standalone mode, where the inner loop 604 determines its own transmit power budget in compliance with the RF exposure limit. In standalone mode, the inner loop 604 may determine the transmit power budget without periodic updates from the outer loop 602 and/or other inner loops 604. In some cases, the inner loop 604 may not communicate with the outer loop 602 while operating in standalone mode. As an example, the inner loop 604 may temporarily stop communications with the outer loop 602 due to the outer loop 602 being in an idle mode or sleep mode, and as such, the inner loop 604 may operate in a standalone mode for purposes of determining RF exposure compliant transmit powers. In some cases, the inner loop 604 may permanently operate in a standalone mode without the updates from the outer loop 602. For example, a WLAN modem and/or a Bluetooth modem may operate in a standalone mode separated from an outer loop and/or inner loop associated with WWAN communications. In such cases of standalone mode, obtaining the transmit power budget may involve the inner loop 604 generating the transmit power budget (without the outer loop 602). As an example, in standalone mode, the inner loop 604 associated with WLAN communications may allocate the transmit power budget among the infra link and the XPAN link as described herein. In some cases, exposure for one or more RATs (e.g., WWAN) may be managed by a first outer loop 602 while one or more other RATs (e.g., WLAN, Bluetooth, and/or NTN) are managed by a second outer loop 602.

A transmit power budget may indicate the maximum allowed time-averaged transmit power that one or more radio(s) can use for a future time interval in compliance with an RF exposure limit. The maximum allowed time-averaged transmit power may correspond to a portion of a rolling time window (e.g., the future time interval), whereas the maximum time-averaged transmit power (e.g., Pₗᵢₘᵢₜ) may correspond to the entire duration of such a time window associated with the RF exposure limit. A total transmit power budget of a wireless device may be shared among multiple RATs, for example, including WWAN, WLAN, NTN, V2X, D2D, and/or short-range (e.g., Bluetooth) communications. In some cases, the total transmit power budget may be allocated to a single RAT.

The inner loop 604 may determine a transmit power 612 for the future time interval based at least in part on the transmit power budget. As an example, based on the transmit power budget supplied by the outer loop 602 and a current duty cycle, the inner loop 604 may determine the transmit power (P_{TX}) according to the following expression:

$${P}_{TX} = {P}_{limit} + {OL}_{limit} + {P}_{DC} \qquad ( 1 )$$

where Pₗᵢₘᵢₜ may be the maximum time-averaged transmit power level, corresponding to an RF exposure limit (e.g., a SAR limit or PD limit); OLₗᵢₘᵢₜ is a power adjustment provided by the outer loop (which may be positive or negative to increase or decrease Pₗᵢₘᵢₜ); and P_{DC} is the additional power obtained by exploiting low duty cycle. OLₗᵢₘᵢₜ may be representative of the transmit power budget or derived from the transmit power budget obtained from the outer loop 602. In some cases, Pₗᵢₘᵢₜ may be selected from a look-up table with various transmit power limits corresponding to various transmission scenarios (e.g., any combination of RAT, carrier frequency, frequency band, antenna, antenna group, beam, etc.) and/or exposure scenarios (e.g., head exposure, body-word exposure, extremity or hand exposure, hotspot exposure, etc.).

As described herein, the outer loop 602 may distribute a total transmit power budget among the inner loops 604 associated with a multi-link service and/or other inner loop(s). A particular inner loop 604 may further distribute the assigned transmit power budget among communication links associated with the multi-link service and/or other communication links. For example, to efficiently allocate the transmit power budget among communication links associated with a particular inner loop (e.g., the infra link and XPAN link for WLAN communications) in a multi-link service, the respective inner loop 604 may distribute the transmit power budget among the communication links based at least in part on the one or more properties associated with the multi-link service.

In some cases, the inner loop 604 may determine the traffic flow associated with the XPAN link, for example, the duty cycle, latency, transfer rate, etc. The inner loop 604 may determine the transmit power for the XPAN link based at least in part on the traffic flow characteristics. As an example, the XPAN link (e.g., the communication links 510b, 510c) may use relatively low transfer rates, such as transfer rates corresponding to any of modulation and coding scheme (MCS) indexes 0-3 in WLAN standards. The inner loop 604 may select a transmit power that facilitates such transfer rate(s), for example, a transmit power lower than Pₗᵢₘᵢₜ due to the low transfer rate. In certain cases, the XPAN service may be used for ultra-low latency communications (e.g., games, virtual reality, augmented reality, etc.), which may affect the duty cycle and/or latency associated with the XPAN link.

In certain cases, the inner loop 604 may determine the channel conditions associated with the XPAN link, and the inner loop 604 may determine the transmit power for the XPAN link based at least in part on the respective channel conditions. The channel conditions may correspond to (or include) one or more channel properties including, for example, a path loss, a round-trip-time (RTT), a transmission range, a channel quality indicator, a signal-to-noise ratio (SNR), a signal-to-interference-plus-noise ratio (SINR), a signal-to-noise-plus-distortion ratio (SNDR), a received signal strength indicator (RSSI), a reference signal received power (RSRP), a reference signal received quality (RSRQ), a data error rate (e.g., a packet error rate or frame error rate), a data error ratio (e.g., a packet error ratio or a frame error rate).

As an example, the inner loop 604 may determine the transmission range and/or path loss associated with the XPAN link, and the inner loop 604 may select a transmit power commensurate with the transmission range and/or path loss. The inner loop 604 may determine the transmission range based on the RSSI, path loss, and/or RTT, for example. In some cases, the wireless device (e.g., a smartphone or tablet) may be in close range to the audio output device (e.g., ear buds or headphones), such that the XPAN link may correspond to close-range communications. In such cases, the inner loop 604 may select a transmit power for the XPAN link based on the close transmission range between the wireless device and the audio output device and reuse the transmit power conserved in the XPAN link to boost the transmit power allocated to the infra link. A transmission-range-based transmit power adjustment at the wireless device may be beneficial in a lossless and lossy audio transmission profile as more transmissions may be output by the wireless device than the audio output device (e.g., ear buds).

In certain aspects, the inner loop 604 may distribute the transmit power budget for WLAN communication among the infra link and XPAN link based at least on dwell times associated with the links, and in some cases, the transmit power(s) determined based on the traffic flows and/or channel conditions. The transmit power budget provided to the WLAN inner loop may be distributed between the infra and XPAN links as a weighted average of the respective dwell times. In some cases, the dwell time of the XPAN link may be shorter than the infra link. As the XPAN link may be used for close-range communication, if different transmit powers for the XPAN and infra links are determined based on the traffic flow and/or channel conditions, the inner loop 604 may distribute the WLAN transmit power budget as a weighted ratio of the respective transmit powers, or a weighted combination of the dwell times and respective transmit powers.

For certain aspects, the inner loop 604 may update the distribution of the transmit power budget allocated to the XPAN and infra links periodically (e.g., every time interval cycle) and/or in response to one or more criteria. As the XPAN and infra links may transmit in different WLAN bands, the wireless device may switch between transmitting via the XPAN link and the infra link. The wireless device may transmit in different transmission occasions for the XPAN link and the infra link. As an example, the inner loop 604 may re-compute the transmit powers allocated to the XPAN and infra links in response to a channel switch between the infra link and the XPAN link. As the XPAN link may be used for close-range communication, the wireless device may transmit at a lower power for the XPAN link than afforded by the transmit power budget—for example, based on the respective transmission range, traffic flow, and/or channel properties associated with the XPAN link—and apply the remaining transmit power budget, which was saved during the respective transmission occasion for the XPAN link, to the transmission for the infra link in a subsequent transmission occasion. Such a transmit power budget distribution may enhance the transmit power allocated to the infra link, which may result in improved wireless communication performance, such as increased throughput, decreased latencies, reduced retransmissions, increased reliability, and/or an increased transmission range.

In certain aspects, the inner loop 604 may determine the transmit power(s) 612 based on other transmit power control(s) 614, such as RF emission controls, RF interference controls, data rate specific power control, etc., in addition to or instead of the RF exposure controls described herein. In some cases, the transmit power control(s) 614 may provide an additional or alternative transmit power budget and/or limit the maximum transmit power determined, such as to control interference or RF emissions. The transmit power controls 614 may provide one or more maximum allowed transmit powers, and the inner loop 604 may select the smallest value among multiple transmit power levels, including the maximum allowed transmit power for RF compliance, for RF emission controls, RF interference controls, data rate specific power control, etc. For example, the transmit power for the time interval may be determined according to an expression that selects the smallest value among multiple maximum allowed values as follows:

$${P}_{TX} = min ( {P}_{TX 1} , … , {P}_{TXN} ) \qquad ( 2 )$$

where P_{TX1} through P_{TXN} may represent N number of maximum allowed transmit powers associated with various transmit power controls. As an example, at least one of P_{TX1} through P_{TXN} includes the maximum allowed transmit power determined according to the RF exposure controls.

The inner loop 604 may provide an indication of transmit power(s) 612 to the radios 606 to be used for transmission(s) in the time interval. The indication of the transmit powers 612 may include a maximum allowed transmit power that can be used for the time interval, where the maximum allowed transmit power(s) are in compliance with the RF exposure limit according to the transmit power budget and/or the transmit power controls 614.

While the examples depicted in FIGS. 5 and 6 are described herein with respect to an XPAN to facilitate understanding, aspects of the present disclosure may also apply to other multi-link service architectures, such as an augmented or virtual reality service architecture, a gaming service (including cloud gaming) architecture, a smart home network, etc. For example, in an augmented or virtual reality service architecture, the first wireless device 502 may be in communication with a headset (e.g., the headset depicted in FIG. 1) in addition to or instead of the second wireless devices 504b, 504c. In a gaming service, the first wireless device 502 may be in communication with a game controller (e.g., the controller depicted in FIG. 1) or any other suitable input-output device.

While the examples depicted in FIGS. 5 and 6 are described herein with respect to determining transmit powers in response to detecting a multi-link service to facilitate understanding, aspects of the present disclosure may also apply to other traffic flows or communication patterns, such as multi-band communications, or multi-RAT communications.

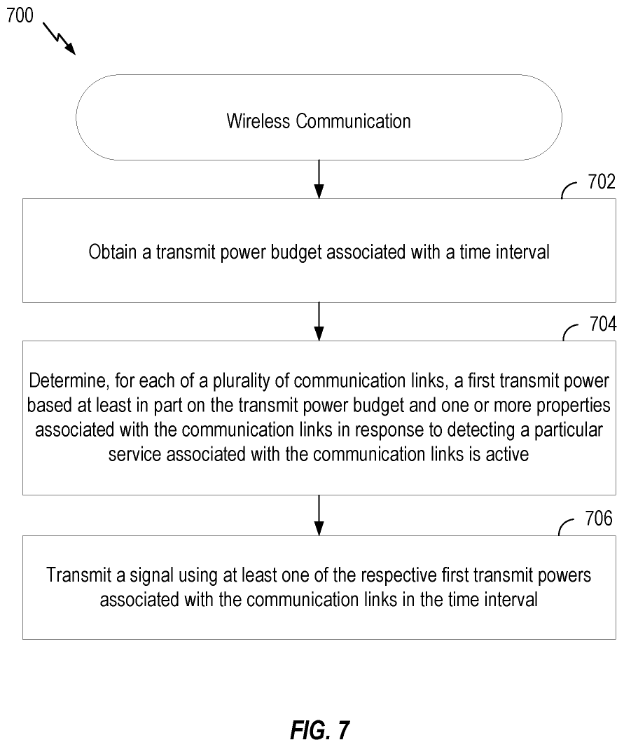

FIG. 7 is a flow diagram illustrating example operations 700 for wireless communication. The operations 700 may be performed, for example, by a wireless device (e.g., the first wireless device 102 in the wireless communication system 100). The operations 700 may be implemented as software components that are executed and run on one or more processors (e.g., the processor 210 and/or the modem 212 of FIG. 2). Further, the transmission and/or reception of signals by the wireless device in the operations 700 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 700 may optionally begin, at block 702, where the wireless device may obtain a transmit power budget (or an indication thereof) associated with a time interval (e.g., the time interval 306). For example, an inner loop (e.g., the inner loop 604) of the wireless device may obtain a transmit power budget associated with a future time interval. The transmit power budget may include or correspond to a maximum allowed time-averaged transmit power based on an RF exposure limit, for example, as described herein with respect to FIGS. 3 and 6. A transmit power budget may indicate the maximum allowed time-averaged transmit power that one or more radio(s) can use for the future time interval in compliance with the RF exposure limit. As a total transmit power budget of the wireless device may be shared among multiple radios across a rolling time window, the transmit power budget may indicate a time-averaged power that is less than or equal to Pₘₐₓ. In some cases, to obtain the transmit power budget, the wireless device may obtain the transmit power budget from a controller (e.g., the outer loop 602) that controls RF exposure associated with one or more RATs. In certain cases, the inner loop may generate the transmit power budget, for example, when the inner loop is operating in a standalone mode without the periodic information (e.g., the second information 610) from the outer loop. In such cases, to obtain the transmit power budget, the wireless device may generate the transmit power budget in a standalone mode. As an example, in standalone mode, the wireless device may distribute the transmit power budget among the XPAN link and the infra link, as described herein.

At block 704, the wireless device may determine, for each of a plurality of communication links, a first transmit power based at least in part on the transmit power budget and one or more properties associated with the communication links in response to detecting a particular service associated with the communication links is active. The particular service may be (or include) a multi-link service, such as an XPAN service as described herein with respect to FIG. 5. As an example, the particular service may include a first communication link (e.g., an XPAN link as described herein with respect to FIG. 5) and a second communication link (e.g., an infra link as described herein with respect to FIG. 5). The first communication link and the second communication link may be communicating in the same time interval, for example, concurrently (in overlapping transmission occasions) or via time division duplexing (in non-overlapping transmission occasions). In certain cases, the communication links may be in different frequency bands (carriers, channels, bandwidths, subdivisions thereof, etc.) For example, the first communication link may be via a first frequency band, and the second communication link may be via a second frequency band different from the first frequency band. In some cases, the communication links may be for the same RAT, for example, WLAN. As an example, the particular service may include an XPAN service, an augmented reality service, a virtual reality service, a gaming service, or a combination thereof. The particular service may correspond to a quality of service (QOS) specification, a latency specification (e.g., ultra-low latency communications), a bit (or information transfer) rate specification, or a combination thereof. The QoS specification may correspond to a particular combination of QoS parameters, such as jitter, minimum latency, average latency, minimum data rate, average data rate, a minimum data error rate, an average data error rate, etc.

At block 706, the wireless device may transmit a signal using at least one of the respective first transmit powers associated with the communication links in the time interval. For example, the wireless device may transmit the signal to another wireless communication device (e.g., any of the second wireless devices 104 depicted in FIG. 1). The signal may indicate (or carry) any of various information, such as data and/or control information. In some cases, the signal may indicate (or carry) one or more packets or data blocks.

In certain aspects, the properties associated with the communication links may include traffic flow properties and/or channel conditions. For example, the properties may include a dwell time, a round-trip time, a distance to another wireless device (e.g., the second wireless device 104, 504), a signal strength (e.g., RSSI), a signal quality (e.g., SNR), a data error rate (e.g., packet error rate), a data error ratio (e.g., packet error ratio), a channel condition, a duty cycle, a physical layer characteristic, or any combination thereof. In some aspects, to determine the first transmit powers, the wireless device may determine, for each of the plurality of communication links, the first transmit power based at least in part on a weighted average of dwell times associated with the communication links.

To determine the first transmit powers, the wireless device may determine, for each of the plurality of communication links, a second transmit power based at least in part on a distance between the wireless device and another wireless device associated with the respective communication link. The second transmit power may correspond to a minimum transmit power that can be successfully used for transmitting a signal to the other wireless device via the communication link based on the distance and/or other properties, such as transfer rate, latency, path loss, round-trip-time, etc. The wireless device may determine, for each of the plurality of communication links, the first transmit power based at least in part on a weighted ratio of the second transmit powers. For example, the XPAN link may be in a close-range scenario, which may allow the wireless device to lower the transmit power for the XPAN link, and the wireless device may use the remaining transmit power budget for the infra link and/or other communication links.

For certain aspects, the wireless device may determine, for each of the plurality of communication links, a second transmit power (e.g., the minimum transmit power that can be used for the respective communication link) based at least in part on a distance between the wireless device and another wireless device associated with the respective communication link. The wireless device may determine, for each of the plurality of communication links, the first transmit power based at least in part on a weighted combination of the second transmit powers and dwell times associated with the communication links.

In certain aspects, the wireless device may update the distribution of the transmit power budget among the communication links periodically or in response to one or more certain criteria. The wireless device may determine a distribution of the transmit power budget among the communication links. For example, the wireless device may allocate 20% of the transmit power budget to the XPAN link and 80% of the transmit power budget to the infra link. The wireless device may update the distribution in response to detecting a change, for example, from transmitting via a first communication link to transmitting via a second communication link.

For certain aspects, the inner loop may inform the outer loop that the particular service is active, for example, as described herein with respect to FIG. 6. The wireless device may provide an indication (to the outer loop) that the particular service is active, and the wireless device may obtain the transmit power budget in response to the indication.

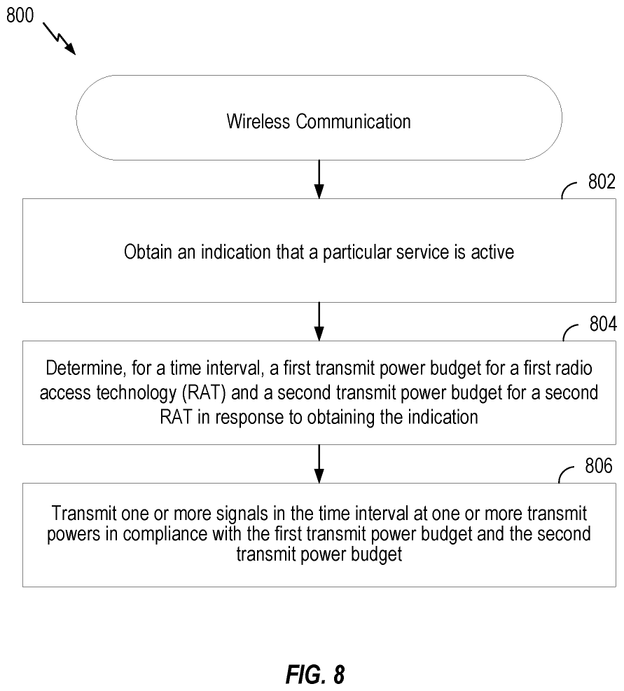

FIG. 8 is a flow diagram illustrating example operations 800 for wireless communication. The operations 800 may be performed, for example, by a wireless device (e.g., the first wireless device 102 in the wireless communication system 100). The operations 800 may be implemented as software components that are executed and run on one or more processors (e.g., the processor 210 and/or the modem 212 of FIG. 2). Further, the transmission and/or reception of signals by the wireless device in the operations 800 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 800 may optionally begin, at block 802, where the wireless device may obtain an indication that a particular service is active. The service may be or include a multi-link service, for example, as described herein with respect to the operations 700 and/or FIG. 5. In some cases, an outer loop may obtain the indication that a particular service is active from an inner loop. In certain cases, to obtain the indication, the outer loop may detect that the service is active. In certain aspects, the indication may include an identifier associated with the service to uniquely identify the service.

At block 804, the wireless device may determine, for a time interval (e.g., the time interval 306), a first transmit power budget for a first RAT (e.g., WLAN) and a second transmit power budget for a second RAT (e.g., Bluetooth) in response to obtaining the indication. For example, the wireless device may distribute a total (available) transmit power budget among at least the first transmit power budget and the second transmit power budget in compliance with an RF exposure limit, for example, as described herein with respect to FIG. 6. In some cases, the wireless device may select a particular distribution associated with the service. As an example, the wireless device may distribute a greater portion of the total transmit power budget to the first transmit power budget than the second transmit power budget. Each of the first transmit power budget and the second transmit power budget may include (or indicate) a maximum allowed time-averaged transmit power based on an RF exposure limit, for example, as described herein with respect to the operations 700 and/or FIG. 6.

At block 806, the wireless device may transmit one or more signals in the time interval at one or more transmit powers in compliance with the first transmit power budget and the second transmit power budget. For example, the wireless device may transmit the signals to another wireless communication device (e.g., any of the second wireless devices 104 depicted in FIG. 1). The signal(s) may indicate (or carry) any of various information, such as data and/or control information. In some cases, the signal(s) may indicate (or carry) one or more packets or data blocks.

In certain aspects, the first RAT and the second RAT may be associated with the service, for example, as described herein with respect to FIG. 5. The first RAT may include a WLAN RAT, and the second RAT may include a Bluetooth RAT, for example. The particular service may include an XPAN service that uses communication links via the first RAT and the second RAT.

For certain aspects, the wireless device may update the distribution in response to requests from the RATs (or controllers thereof such as the inner loops). The wireless device may obtain one or more requests associated with the first transmit power budget and the second transmit power budget, and the wireless device may update a distribution of the total transmit power budget among at least the first transmit power budget and the second transmit power budget in response to the one or more requests.

In some aspects, the wireless device may determine the second transmit power budget based on a base reserve associated with the second RAT, for example, as described herein with respect to FIG. 6. The second transmit power budget may correspond to a base reserve (also referred to as a “minimum reserve”) for communications via the second RAT. The base reserve may correspond to a guaranteed reserve of transmit power for communication(s) via the second RAT in a time window associated with a time-averaged RF exposure limit. The base reserve may be set to facilitate the guaranteed reserve of transmit power for a particular duration, such as the time-averaging time window or a portion thereof. To determine the first transmit power budget and the second transmit power budget, the wireless device may distribute a difference between a total transmit power budget and the base reserve to the first transmit power budget.

In certain aspects, the wireless device may determine the transmit powers based on the respective transmit power budgets, for example, as described herein with respect to the operations 700 and/or FIG. 6. The wireless device may determine the one or more transmit powers based at least in part on the first transmit power budget and the second transmit power budget in compliance with an RF exposure limit, for example, as described herein with respect to FIG. 3.

For certain aspects, the wireless device may share the transmit power budget(s) among multiple communication links in the same time interval as the wireless device may be transmitting via such communication links in the time interval. For example, the wireless device may transmit a first signal at a first transmit power through a first communication link (e.g., an infra link) via the first RAT in compliance with the first transmit power budget. In some cases, the wireless device may transmit a second signal at a second transmit power through a second communication link (e.g., an XPAN link) via the first RAT in compliance with the first transmit power budget. The wireless device may transmit a third signal at a third transmit power via the second RAT (e.g., Bluetooth) in compliance with the second transmit power budget. The wireless device may transmit any combination of the first signal, the second signal, and the third signal in the time interval, which may occur concurrently or in non-overlapping transmission occasions.

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

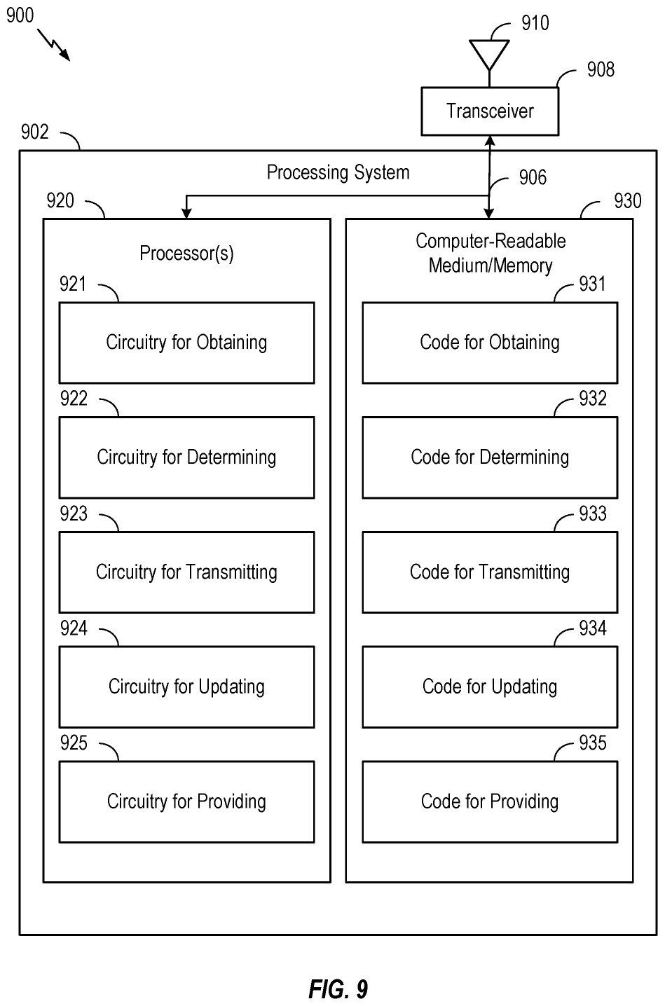

FIG. 9 depicts aspects of an example communications device 900. In some aspects, communications device 900 is a wireless communication device, such as the first wireless device 102 described above with respect to FIGS. 1 and 2.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of any of the processor 210 and/or the modem 212, as described with respect to FIG. 2. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the operations 700 and/or 800 described with respect to FIG. 7 and/or FIG. 8, or any aspect related to the operations described herein. Note that reference to a processor performing a function of communications device 900 may include one or more processors performing that function of communications device 900. Reference to one or more processors performing multiple functions may include any one of the one or more processors performing any one of the multiple functions.

In the depicted example, computer-readable medium/memory 930 stores code (e.g., executable instructions) for obtaining 931, code for determining 932, code for transmitting 933, code for updating 934, code for providing 935, or any combination thereof. Processing of the code 931-935 may cause the communications device 900 to perform the operations 700 and/or 800 described with respect to FIG. 7 and/or FIG. 8, or any aspect related to operations described herein.

The one or more processors 920 include circuitry configured to implement (e.g., execute) the code stored in the computer-readable medium/memory 930, including circuitry for obtaining 921, circuitry for determining 922, circuitry for transmitting 923, circuitry for updating 924, circuitry for providing 925, or any combination thereof. Processing with circuitry 921-925 may cause the communications device 900 to perform the operations 700 and/or 800 described with respect to FIG. 7 and/or FIG. 8, or any aspect related to operations described herein.

Various components of the communications device 900 may provide means for performing the operations 700 and/or 800 described with respect to FIG. 7 and/or FIG. 8, or any aspect related to operations described herein. For example, means for transmitting, sending or outputting for transmission may include the TX path 214 and/or antenna(s) 218 of the first wireless device 102 illustrated in FIG. 2 and/or transceiver 908 and antenna 910 of the communications device 900 in FIG. 9. Means for receiving or obtaining may include the RX path 216 and/or antenna(s) 218 of the first wireless device illustrated in FIG. 2 and/or transceiver 908 and antenna 910 of the communications device 900 in FIG. 9. Means for obtaining, means for determining, means for updating, and/or means for providing may include one or more processors, such as the processor 210 and/or modem 212 depicted in FIG. 2 and/or the processor(s) 920 in FIG. 9.

### Example Aspects

Implementation examples are described in the following numbered clauses:

Aspect 1: A method of wireless communication by a wireless device, comprising: obtaining a transmit power budget associated with a time interval; determining, for each of a plurality of communication links, a first transmit power based at least in part on the transmit power budget and one or more properties associated with the communication links in response to detecting a particular service associated with the communication links is active; and transmitting a signal using at least one of the respective first transmit powers associated with the communication links in the time interval.

Aspect 2: The method of Aspect 1, wherein the one or more properties comprise: a dwell time, a round-trip time, a distance to another wireless device, a signal strength, a signal quality, a data error rate, a data error ratio, a channel condition, a duty cycle, a physical layer characteristic, or any combination thereof.

Aspect 3: The method of Aspect 1 or 2, wherein determining, for each of the plurality of communication links, the first transmit power comprises determining, for each of the plurality of communication links, the first transmit power based at least in part on a weighted average of dwell times associated with the communication links.

Aspect 4: The method according to any of Aspects 1-3, wherein determining, for each of the plurality of communication links, the first transmit power comprises: determining, for each of the plurality of communication links, a second transmit power based at least in part on a distance between the wireless device and another wireless device associated with the respective communication link; and determining, for each of the plurality of communication links, the first transmit power based at least in part on a weighted ratio of the second transmit powers.

Aspect 5: The method according to any of Aspects 1-4, wherein determining, for each of the plurality of communication links, the transmit power comprises: determining, for each of the plurality of communication links, a second transmit power based at least in part on a distance between the wireless device and another wireless device associated with the respective communication link; and determining, for each of the plurality of communication links, the first transmit power based at least in part on a weighted combination of the second transmit powers and dwell times associated with the communication links.

Aspect 6: The method according to any of Aspects 1-5, wherein the particular service comprises a first communication link and a second communication link, and wherein the first communication link and the second communication link are communicating in the time interval.

Aspect 7: The method to any of Aspects 1-5, wherein the particular service comprises a first communication link and a second communication link, wherein the first communication link is for a radio access technology via a first frequency band, and wherein the second communication link is for the radio access technology via a second frequency band different from the first frequency band.

Aspect 8: The method of Aspect 7, wherein the radio access technology is wireless local area network (WLAN).

Aspect 9: The method according to any of Aspects 6-8, wherein the particular service comprises an extended personal audio network (XPAN) service, an augmented reality service, a virtual reality service, a gaming service, or a combination thereof.

Aspect 10: The method according to any of Aspects 1-9, wherein the particular service corresponds to a quality of service specification, a latency specification, a bit rate specification, or a combination thereof.

Aspect 11: The method according to any of Aspects 1-10, wherein: determining, for each of the plurality of communication links, the first transmit power comprises determining a distribution of the transmit power budget among the communication links; and the method further comprises updating the distribution in response to detecting a change from transmitting via a first communication link to transmitting via a second communication link.

Aspect 12: The method according to any of Aspects 1-11, further comprising providing an indication that the particular service is active, wherein obtaining the transmit power budget comprises obtaining the transmit power budget in response to the indication.

Aspect 13: The method according to any of Aspects 1-12, wherein the transmit power budget comprises a maximum allowed time-averaged transmit power based on a radio frequency (RF) exposure limit.

Aspect 14: The method according to any of Aspects 1-13, wherein obtaining the transmit power budget comprises obtaining the transmit power budget from a controller that controls radio frequency (RF) exposure associated with a plurality of radio access technologies including a radio access technology associated with the communication links.

Aspect 15: A method of wireless communication by a wireless device, comprising: obtaining an indication that a particular service is active; determining, for a time interval, a first transmit power budget for a first radio access technology (RAT) and a second transmit power budget for a second RAT in response to obtaining the indication; and transmitting one or more signals in the time interval at one or more transmit powers in compliance with the first transmit power budget and the second transmit power budget.

Aspect 16: The method of Aspect 15, wherein determining the first transmit power budget and the second transmit power budget comprises distributing a total transmit power budget among at least the first transmit power budget and the second transmit power budget in compliance with a radio frequency exposure limit.

Aspect 17: The method of Aspect 16, wherein distributing the total transmit power budget comprises distributing a greater portion of the total transmit power budget to the first transmit power budget than the second transmit power budget.

Aspect 18: The method of Aspect 17, wherein: the first RAT comprises a wireless local area network (WLAN) RAT; the second RAT comprises a Bluetooth RAT; and the particular service comprises an extended personal audio network (XPAN) service that uses communication links via the first RAT and the second RAT.

Aspect 19: The method according to any of Aspects 16-18, further comprising: obtaining one or more requests associated with the first transmit power budget and the second transmit power budget; and updating a distribution of the total transmit power budget among at least the first transmit power budget and the second transmit power budget in response to the one or more requests.

Aspect 20: The method according to any of Aspects 15-19, wherein each of the first transmit power budget and the second transmit power budget comprises a maximum allowed time-averaged transmit power based on a radio frequency (RF) exposure limit.

Aspect 21: The method according to any of Aspects 15-20, wherein the second transmit power budget corresponds to a base reserve for communications via the second RAT.

Aspect 22: The method of Aspect 21, wherein determining the first transmit power budget and the second transmit power budget comprises distributing a difference between a total transmit power budget and the base reserve to the first transmit power budget.

Aspect 23: The method of Aspect 21 or 22, wherein the base reserve corresponds to a guaranteed reserve of transmit power for communications via the second RAT in a time window associated with a time-averaged RF exposure limit.

Aspect 24: The method according to any of Aspects 21-23, wherein the first RAT comprises a wireless local area network RAT and wherein the second RAT comprises a Bluetooth RAT.

Aspect 25: The method according to any of Aspects 15-24, wherein the particular service comprises an extended personal audio network (XPAN) service, an augmented reality service, a virtual reality service, a gaming service, or a combination thereof.

Aspect 26: The method according to any of Aspects 15-25, further comprising determining the one or more transmit powers based at least in part on the first transmit power budget and the second transmit power budget in compliance with an RF exposure limit.

Aspect 27: The method according to any of Aspects 15-26, wherein transmitting the one or more signals comprises transmitting a first signal at a first transmit power through a first communication link via the first RAT in compliance with the first transmit power budget.

Aspect 28: The method of Aspect 27, wherein transmitting the one or more signals further comprises transmitting a second signal at a second transmit power through a second communication link via the first RAT in compliance with the first transmit power budget.

Aspect 29: The method of Aspect 27 or 28, wherein transmitting the one or more signals comprises transmitting a third signal at a third transmit power via the second RAT in compliance with the second transmit power budget.

Aspect 30: An apparatus for wireless communication, comprising: a memory; and one or more processors coupled to the memory, the one or more processors being configured to: obtain a transmit power budget associated with a time interval, determine, for each of a plurality of communication links, a first transmit power based at least in part on the transmit power budget and one or more properties associated with the communication links in response to detecting a particular service associated with the communication links is active, and control transmission of a signal using at least one of the respective first transmit powers associated with the communication links in the time interval.

Aspect 31: An apparatus for wireless communication, comprising: a memory; and one or more processors coupled to the memory, the one or more processors being configured to: obtain an indication that a particular service is active, determine, for a time interval, a first transmit power budget for a first radio access technology (RAT) and a second transmit power budget for a second RAT in response to obtaining the indication, and control transmission of one or more signals in the time interval at one or more transmit powers in compliance with the first transmit power budget and the second transmit power budget.

Aspect 32: An apparatus for wireless communication, comprising: means for obtaining a transmit power budget associated with a time interval; means for determining, for each of a plurality of communication links, a first transmit power based at least in part on the transmit power budget and one or more properties associated with the communication links in response to detecting a particular service associated with the communication links is active; and means for transmitting a signal using at least one of the respective first transmit powers associated with the communication links in the time interval.

Aspect 33: An apparatus for wireless communication, comprising: means for obtaining an indication that a particular service is active; means for determining, for a time interval, a first transmit power budget for a first radio access technology (RAT) and a second transmit power budget for a second RAT in response to obtaining the indication; and means for transmitting one or more signals in the time interval at one or more transmit powers in compliance with the first transmit power budget and the second transmit power budget.

Aspect 34: A computer-readable medium having instructions stored thereon for: obtaining a transmit power budget associated with a time interval; determining, for each of a plurality of communication links, a first transmit power based at least in part on the transmit power budget and one or more properties associated with the communication links in response to detecting a particular service associated with the communication links is active; and transmitting a signal using at least one of the respective first transmit powers associated with the communication links in the time interval.

Aspect 35: A computer-readable medium having instructions stored thereon for: obtaining an indication that a particular service is active; determining, for a time interval, a first transmit power budget for a first radio access technology (RAT) and a second transmit power budget for a second RAT in response to obtaining the indication; and transmitting one or more signals in the time interval at one or more transmit powers in compliance with the first transmit power budget and the second transmit power budget.

Aspect 36: An apparatus, comprising: a memory comprising computer-executable instructions; and one or more processors configured to execute the computer-executable instructions and cause the apparatus to perform a method in accordance with any of Aspects 1-29.

Aspect 37: An apparatus, comprising means for performing a method in accordance with any of Aspects 1-29.

Aspect 38: A non-transitory computer-readable medium comprising computer-executable instructions that, when executed by one or more processors of a processing system, cause the processing system to perform a method in accordance with any of Aspects 1-29.

Aspect 39: A computer program product embodied on a computer-readable storage medium comprising code for performing a method in accordance with any of Aspects 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The invention claimed is:

1. A method of wireless communication by a wireless device, comprising:
obtaining a transmit power budget associated with a time interval;
determining, for each of a plurality of communication links, a first transmit power based at least in part on the transmit power budget and one or more properties associated with the communication links in response to detecting a particular service associated with the communication links is active; and
transmitting a signal using at least one of the respective first transmit powers associated with the communication links in the time interval.

2. The method of claim 1, wherein the one or more properties comprise:
a dwell time,
a round-trip time,
a distance to another wireless device,
a signal strength,
a signal quality,
a data error rate,
a data error ratio,
a channel condition,
a duty cycle,
a physical layer characteristic, or
any combination thereof.

3. The method of claim 1, wherein determining, for each of the plurality of communication links, the first transmit power comprises determining, for each of the plurality of communication links, the first transmit power based at least in part on a weighted average of dwell times associated with the communication links.

4. The method of claim 1, wherein determining, for each of the plurality of communication links, the first transmit power comprises:
determining, for each of the plurality of communication links, a second transmit power based at least in part on a distance between the wireless device and another wireless device associated with the respective communication link; and
determining, for each of the plurality of communication links, the first transmit power based at least in part on a weighted ratio of the second transmit powers.

5. The method of claim 1, wherein determining, for each of the plurality of communication links, the transmit power comprises:
determining, for each of the plurality of communication links, a second transmit power based at least in part on a distance between the wireless device and another wireless device associated with the respective communication link; and
determining, for each of the plurality of communication links, the first transmit power based at least in part on a weighted combination of the second transmit powers and dwell times associated with the communication links.

6. The method of claim 1, wherein the particular service comprises a first communication link and a second communication link, and wherein the first communication link and the second communication link are communicating in the time interval.

7. The method of claim 1, wherein the particular service comprises a first communication link and a second communication link, wherein the first communication link is for a radio access technology and via a first frequency band, and wherein the second communication link is for the radio access technology and via a second frequency band different from the first frequency band.

8. The method of claim 7, wherein the radio access technology is wireless local area network (WLAN).

9. The method of claim 6, wherein the particular service comprises an extended personal audio network (XPAN) service, an augmented reality service, a virtual reality service, a gaming service, or a combination thereof.

10. The method of claim 1, wherein the particular service corresponds to a quality of service specification, a latency specification, a bit rate specification, or a combination thereof.

11. The method of claim 1, wherein:
determining, for each of the plurality of communication links, the first transmit power comprises determining a distribution of the transmit power budget among the communication links; and
the method further comprises updating the distribution in response to detecting a change from transmitting via a first communication link to transmitting via a second communication link.

12. The method of claim 1, further comprising providing an indication that the particular service is active, wherein obtaining the transmit power budget comprises obtaining the transmit power budget in response to the indication.

13. A method of wireless communication by a wireless device, comprising:
obtaining an indication that a particular service is active;
determining, for a time interval, a first transmit power budget for a first radio access technology (RAT) and a second transmit power budget for a second RAT in response to obtaining the indication; and
transmitting one or more signals in the time interval at one or more transmit powers in compliance with the first transmit power budget and the second transmit power budget.

14. The method of claim 13, wherein determining the first transmit power budget and the second transmit power budget comprises distributing a total transmit power budget among at least the first transmit power budget and the second transmit power budget in compliance with a radio frequency exposure limit.

15. The method of claim 14, wherein distributing the total transmit power budget comprises distributing a greater portion of the total transmit power budget to the first transmit power budget than the second transmit power budget.

16. The method of claim 15, wherein:
the first RAT comprises a wireless local area network (WLAN) RAT;
the second RAT comprises a Bluetooth RAT; and
the particular service comprises an extended personal audio network (XPAN) service that uses communication links via the first RAT and the second RAT.

17. The method of claim 14, further comprising:
obtaining one or more requests associated with the first transmit power budget and the second transmit power budget; and
updating a distribution of the total transmit power budget among at least the first transmit power budget and the second transmit power budget in response to the one or more requests.

18. The method of claim 13, wherein each of the first transmit power budget and the second transmit power budget comprises a maximum allowed time-averaged transmit power based on a radio frequency (RF) exposure limit.

19. The method of claim 13, wherein the second transmit power budget corresponds to a base reserve for communications via the second RAT.

20. The method of claim 19, wherein determining the first transmit power budget and the second transmit power budget comprises distributing a difference between a total transmit power budget and the base reserve to the first transmit power budget.

21. The method of claim 19, wherein the base reserve corresponds to a guaranteed reserve of transmit power for communications via the second RAT in a time window associated with a time-averaged RF exposure limit.

22. The method of claim 19, wherein the first RAT comprises a wireless local area network RAT and wherein the second RAT comprises a Bluetooth RAT.

23. The method of claim 13, wherein the particular service comprises an extended personal audio network (XPAN) service, an augmented reality service, a virtual reality service, a gaming service, or a combination thereof.

24. The method of claim 13, further comprising determining the one or more transmit powers based at least in part on the first transmit power budget and the second transmit power budget in compliance with an RF exposure limit.

25. The method of claim 13, wherein transmitting the one or more signals comprises transmitting a first signal at a first transmit power through a first communication link via the first RAT in compliance with the first transmit power budget.

26. The method of claim 25, wherein transmitting the one or more signals further comprises transmitting a second signal at a second transmit power through a second communication link via the first RAT in compliance with the first transmit power budget.

27. The method of claim 25, wherein transmitting the one or more signals comprises transmitting a third signal at a third transmit power via the second RAT in compliance with the second transmit power budget.

28. An apparatus for wireless communication, comprising:
a memory; and
one or more processors coupled to the memory, the one or more processors being configured to:
obtain a transmit power budget associated with a time interval,
determine, for each of a plurality of communication links, a first transmit power based at least in part on the transmit power budget and one or more properties associated with the communication links in response to detecting a particular service associated with the communication links is active, and
control transmission of a signal using at least one of the respective first transmit powers associated with the communication links in the time interval.

29. The apparatus of claim 28, wherein to determine, for each of the plurality of communication links, the first transmit power, the one or more processors are further configured to determine, for each of the plurality of communication links, the first transmit power based at least in part on a weighted average of dwell times associated with the communication links.

30. An apparatus for wireless communication, comprising:
a memory; and
one or more processors coupled to the memory, the one or more processors being configured to:
obtain an indication that a particular service is active,
determine, for a time interval, a first transmit power budget for a first radio access technology (RAT) and a second transmit power budget for a second RAT in response to obtaining the indication, and
control transmission of one or more signals in the time interval at one or more transmit powers in compliance with the first transmit power budget and the second transmit power budget.
